(19) United States
(12) Patent Application Publication
(10) Pub. No.: US 2014/0211194 A1
(43) Pub. Date: Jul. 31, 2014

(54) COST-EFFECTIVE LIDAR SENSOR FOR MULTI-SIGNAL DETECTION, WEAK SIGNAL DETECTION AND SIGNAL DISAMBIGUATION AND METHOD OF USING SAME

(71) Applicants: ANGUS PACALA, MENLO PARK, CA (US); TIANYUE YU, SUNNYVALE, CA (US); LOUAY ELDADA, SUNNYVALE, CA (US)

(72) Inventors: ANGUS PACALA, MENLO PARK, CA (US); TIANYUE YU, SUNNYVALE, CA (US); LOUAY ELDADA, SUNNYVALE, CA (US)

(73) Assignee: QUANERGY SYSTEMS, INC., SUNNYVALE, CA (US)

(21) Appl. No.: 14/165,566

(22) Filed: Jan. 27, 2014

Related U.S. Application Data
(60) Provisional application No. 61/757,222, filed on Jan. 27, 2013.

(51) Int. Cl. G01S 17/06

(52) U.S. Cl. CPC G01S 17/06
USPC 356/5.01

(57) ABSTRACT

A lidar-based apparatus and method are used for multi-signal detection, weak signal detection and signal disambiguation through waveform approximation utilizing a multi-channel time-to-digital converter (TDC) electronic circuit, with each TDC having an individually adjustable voltage threshold. This advanced TDC-based pulse width time-of-flight (ToF) approach achieves the low cost associated with the TDC-based pulse width ToF approach while solving the signal quality issues associated with the standard single-threshold TDC-based approach.

### PRIORITY CLAIM

The present Application claims the benefit of priority from U.S. Provisional Application Ser. No. 61/757,222, filed Jan. 27, 2013.

### References Cited

U.S. Patent Documents

| | | |
|---|---|---|
| 5,455,669 | October 1995 | Wetteborn |
| 7,295,298 B2 | November 2007 | Willhoeft |
| 7,345,271 B2 | March 2008 | Boehlau |
| 7,570,793 B2 | August 2009 | Lages |
| 7,684,590 B2 | March 2010 | Kämpchen |
| 7,746,271 B2 | June 2010 | Fürstenberg |
| 7,746,449 B2 | June 2010 | Ray |
| 7,969,558 B2 | June 2011 | Hall |
| 2011/0216304 A1 | September 2011 | Hall |
| 2011/0313722 A1 | December 2011 | Zhu |

### FIELD OF THE INVENTION

The present invention relates generally to the field of vehicle or robot or automated equipment safety and efficiency, and more particularly to the use of cost-effective robust time-of-flight (ToF) lidar sensors for real-time wide-field-of-view three-dimensional mapping and object detection, tracking and/or classification under a broad range of conditions, including adverse weather conditions, high optical noise, and weak reflections.

### BACKGROUND OF THE INVENTION

A lidar sensor is a light detection and ranging sensor. It is an optical remote sensing module that can measure the distance to a target or objects in a landscape, by irradiating the target or landscape with light, using pulses (or alternatively a modulated signal) from a laser, and measuring the time it takes photons to travel to said target or landscape and return after reflection to a receiver in the lidar module. The waveforms of the reflected pulses are detected and analyzed to determine which pulses represent reflections from solid objects whose sensing is desired (e.g., vehicle, person, wall, tree) as opposed to errant pulses reflected by environmental elements whose sensing is not desired (e.g., rain, dust). Errant pulses can have a low intensity (due to the small size or low reflectivity of the element causing the reflection) and/or a broadened width (due to the diffuse reflection obtained in backscattering). When one outgoing pulse generates multiple return pulses, the detection and analysis of the return pulses allow the selection of the pulse that corresponds to the object whose sensing is desired, with the time of flight and the intensity of the selected pulse being measures of the distance and the reflectivity of the sensed object, respectively.

Conventional waveform digitization and analysis permit accurate measurements of reflected laser pulses, however the method is expensive due to the costly components needed, such as fast Analog-to-Digital Converters (ADCs) that digitize the pulses (per U.S. Pat. No. 7,969,558), and field-programmable gate arrays (FPGAs) or fast digital signal processors (DSPs) that process the data.

Lower cost pulse width ToF methods have been developed more recently. In this approach, pulses that cross a voltage threshold trigger a Time-to-Digital Converter (TDC), which records the time of the event. A computer locates the pulse with the largest width, and uses a correlation table to compensate for “walk” error and calculate an assumed intensity. This low-cost approach has significant performance issues, including:

It can miss low intensity pulses that do not cross the voltage threshold trigger; this problem cannot be solved by lowering the voltage threshold trigger setting, as this change would increase the noise level

It incorrectly interprets returns from environmental elements whose sensing is not desired (e.g., rain, fog, dust), as a single pulse width measurement on a waveform can be ambiguous since it provides no information on the waveform shape, therefore not enabling to distinguish narrow waveforms of pulses reflected by objects whose sensing is desired from broadened waveforms backscattered by environmental elements whose sensing is not desired (e.g., rain, fog, dust)

It conventionally records only one to a few return pulses, making it unreliable in poor weather, when a large number of errant pulses are commonly reflected in addition to the desired reflected pulse.

### SUMMARY OF THE INVENTION

A lidar-based apparatus and method are used for multi-signal detection, weak signal detection and signal disambiguation through waveform approximation utilizing a multi-channel time-to-digital converter (TDC) electronic circuit, with each TDC having an individually adjustable voltage threshold. This advanced TDC-based pulse width time-of-flight (ToF) approach achieves the low cost associated with the TDC-based pulse width ToF approach while solving the signal quality issues associated with the standard single-threshold TDC-based approach.

### DESCRIPTION OF THE DRAWINGS

The following drawings are illustrative of embodiments of the present invention and are not intended to limit the invention as encompassed by the claims forming part of the application.

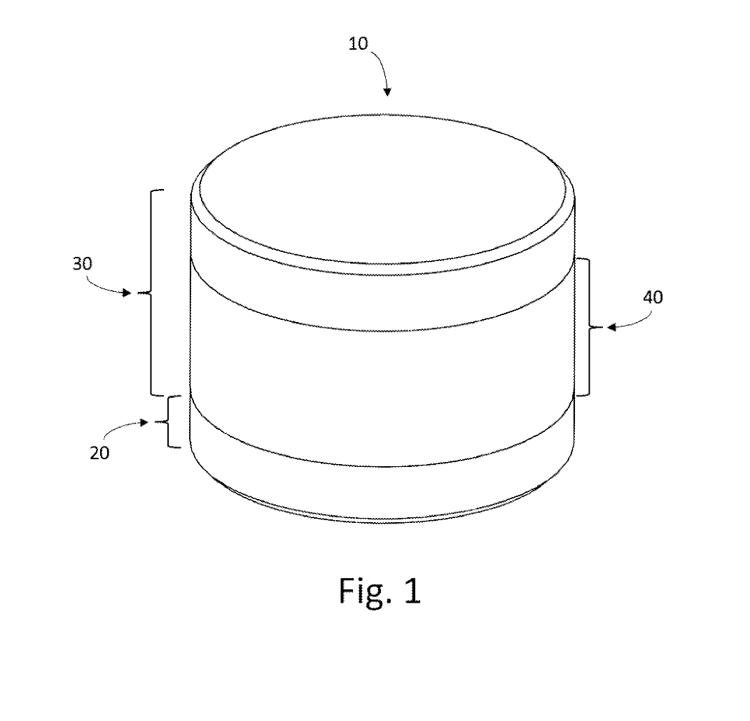

The schematic diagram of FIG. 1 provides an external view of a lidar sensor 10 that can be used in the present invention, depicting a static base 20 and a static head assembly 30 that includes a window 40 that is transparent at the wavelength of the laser used in each transmitter.

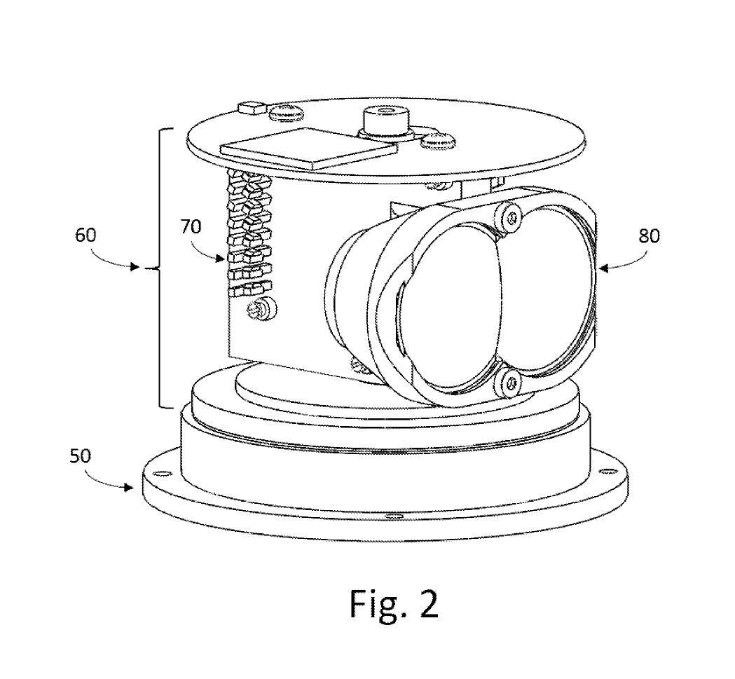

The schematic diagram of FIG. 2 provides an internal view of a lidar sensor that can be used in the present invention, depicting a static base 50 that contains a motor and distributed electronics, and a spinning turret 60 that contains optoelectronic components 70 (including optical transmitters and receivers), collimation and focusing lenses 80 and distributed electronics. The multi-channel TDC electronic circuitry of the present invention can be located on said static base and/or on said spinning turret.

### DETAILED DESCRIPTION OF THE INVENTION

A lidar-based apparatus and method are used for multi-signal detection, weak signal detection and signal disambiguation through waveform approximation utilizing a multi-channel time-to-digital converter (TDC) electronic circuit, with each TDC having an individually adjustable voltage threshold. This advanced TDC-based pulse width ToF approach achieves the low cost associated with the TDC-based pulse width ToF approach while solving the signal quality issues associated with the standard single-threshold TDC-based approach: (1) the lowest voltage threshold is set sufficiently low to avoid missing low intensity pulses; (2) the waveform approximation achieved with multiple voltage thresholds eliminates ambiguity about the shape of incoming pulses, allowing to sort between reflections from objects whose sensing is desired and backscattering from environmental elements whose sensing is not desired (e.g., rain, dust), as the latter causes a broadening in the waveform; when two voltage thresholds are used, a trapezoidal waveform approximation is obtained; when four voltage thresholds are used, the waveform approximation obtained is substantially similar to the result obtained with the significantly more expensive conventional waveform digitization approach; (3) it further enhances poor weather performance, when a large number of errant pulses are commonly reflected in addition to the desired reflected pulse, as it is capable of recording virtually unlimited pulses by means of a data buffer and a high speed data bus. The multi-channel TDC electronic circuitry with multiple voltage thresholds can be implemented with discrete integrated circuits (ICs), in the form of FPGA logic, as part of an application-specific integrated circuit (ASIC), or integrated into the pixels of a detector array (e.g., Single-Photon Avalanche Diode [SPAD] array).

What is claimed is:

1. A time-of-flight lidar ranging apparatus comprising an electronic circuit that comprises a plurality of time-to-digital converters with individually adjustable voltage thresholds.

2. The apparatus of claim 1 wherein said electronic circuit is an application-specific integrated circuit.

3. The apparatus of claim 1 wherein said plurality of time-to-digital converters are capable of recording unlimited pulses.

4. The apparatus of claim 3 wherein said unlimited pulses are recorded at a continuous return pulse rate of up to 2 GHz.

5. The apparatus of claim 3 wherein said unlimited pulses are recorded at a continuous return pulse rate of up to 200 MHz.

6. The apparatus of claim 1 wherein said electronic circuit comprises four time-to-digital converters with individually adjustable voltage thresholds.

7. The apparatus of claim 6 wherein said electronic circuit is an application-specific integrated circuit.

8. The apparatus of claim 6 wherein said four time-to-digital converters are capable of recording unlimited pulses.

9. The apparatus of claim 8 wherein said unlimited pulses are recorded at a continuous return pulse rate of up to 2 GHz.

10. The apparatus of claim 8 wherein said unlimited pulses are recorded at a continuous return pulse rate of up to 200 MHz.

11. The apparatus of claim 6 wherein said four time-to-digital converters have their individual voltage thresholds set at different values to support waveform approximation.

12. The apparatus of claim 6 wherein the time-to-digital converter with the lowest voltage threshold has a trigger setting that allows the detection of weak signals slightly above the noise level.

13. The apparatus of claim 1 wherein said electronic circuit comprises two time-to-digital converters with individually adjustable voltage thresholds.

14. The apparatus of claim 13 wherein said electronic circuit is an application-specific integrated circuit.

15. The apparatus of claim 13 wherein said two time-to-digital converters are capable of recording unlimited pulses.

16. The apparatus of claim 15 wherein said unlimited pulses are recorded at a continuous return pulse rate of up to 2 GHz.

17. The apparatus of claim 15 wherein said unlimited pulses are recorded at a continuous return pulse rate of up to 200 MHz.

18. The apparatus of claim 13 wherein said two time-to-digital converters have their individual voltage thresholds set at different values to support trapezoidal waveform approximation.

19. The apparatus of claim 13 wherein the time-to-digital converter with the lower voltage threshold has a trigger setting that allows the detection of weak signals slightly above the noise level.

20. A method for ranging utilizing a time-of-flight lidar apparatus comprising an electronic circuit that comprises a plurality of time-to-digital converters with individually adjustable voltage thresholds.

21. The method of claim 20 wherein said electronic circuit is an application-specific integrated circuit.

22. The method of claim 20 wherein said plurality of time-to-digital converters are capable of recording unlimited pulses.

23. The method of claim 20 wherein said electronic circuit comprises four time-to-digital converters with individually adjustable voltage thresholds.

24. The method of claim 23 wherein said electronic circuit is an application-specific integrated circuit.

25. The method of claim 23 wherein said four time-to-digital converters are capable of recording unlimited pulses.

26. The method of claim 23 wherein said four time-to-digital converters have their individual voltage thresholds set at different values to support waveform approximation.

27. The method of claim 23 wherein the time-to-digital converter with the lowest voltage threshold has a trigger setting that allows the detection of weak signals slightly above the noise level.

28. The method of claim 20 wherein said electronic circuit comprises two time-to-digital converters with individually adjustable voltage thresholds.

29. The method of claim 28 wherein said electronic circuit is an application-specific integrated circuit.

30. The method of claim 28 wherein said two time-to-digital converters are capable of recording unlimited pulses.

31. The method of claim 28 wherein said two time-to-digital converters have their individual voltage thresholds set at different values to support trapezoidal waveform approximation.

32. The method of claim 28 wherein the time-to-digital converter with the lower voltage threshold has a trigger setting that allows the detection of weak signals slightly above the noise level.
